(19) United States
(12) Patent Application Publication
(10) Pub. No.: US 2016/0083033 A1
(43) Pub. Date: Mar. 24, 2016

(54) WARNING LAMP FOR A BICYCLE

(71) Applicant: Zi-Ju LIU, Taoyuan City (TW)

(72) Inventor: Zi-Ju LIU, Taoyuan City (TW)

(21) Appl. No.: 14/852,490

(22) Filed: Sep. 11, 2015

(30) Foreign Application Priority Data
Sep. 18, 2014 (TW) 103132281

(51) Int. Cl. B62J 6/00; B62J 6/16

(52) U.S. Cl. CPC B62J 6/003; B62J 6/16

(57) ABSTRACT

A warning lamp of a bicycle includes a body, a circuit board, two light-emitting units, a power supply and a control switch. The body has a holding portion and a cap portion. The holding portion has an inner end and an outer end. The cap portion is connected with the outer end of the holding portion and has a mounting chamber. The circuit board is mounted inside the mounting chamber. The two light-emitting units are mounted inside the mounting chamber and electrically connected to the circuit board. The power supply is electrically connected to the circuit board to supply power to and light up the light-emitting units. The control switch is mounted on the body and is electrically connected to the circuit board to control the light-emitting units to turn on or off.

### BACKGROUND OF THE INVENTION

1. Field of the Invention

The present invention relates to a lamp and, more particularly, to a warning lamp mounted on a bicycle handlebar.

2. Description of the Related Art

Conventional bicycles normally have front light and back light for front and rear illumination. However, there is no warning lamp available to the conventional bicycles for alert upon making a turn, thus posting a threat against nighttime safety of cyclists and pedestrians in the neighborhood of the cyclists.

### SUMMARY OF THE INVENTION

An objective of the present invention is to provide a warning lamp mounted on each of the two handlebars of a bicycle as a direction indicator light.

To achieve the foregoing objective, the warning lamp for a bicycle is mounted on each of two handlebars of a bicycle, wherein each handlebar has a hollow bar, a connection end and a free end, the connection end is connected to a frame of the bicycle, and the free end is opposite to the connection end. The warning lamp includes a body, a circuit board, two light-emitting units, a power supply and a control switch.

The body has a holding portion and a cap portion.

The holding portion is adapted to mount around the hollow bar of each handlebar of the bicycle and has an inner end and an outer end. The inner end is adapted to correspond to the connection end of the handlebar. The outer end is adapted to correspond to the free end of the handlebar.

The cap portion is connected with the outer end of the holding portion of the body and has a mounting chamber defined inside the cap portion.

The circuit board is mounted inside the mounting chamber of the cap portion.

The two light-emitting units are mounted inside the mounting chamber and are electrically connected to the circuit board.

The power supply is electrically connected to the circuit board to supply power to and light up the two light-emitting units.

The control switch is mounted on the holding portion of the body and is electrically connected to the circuit board to control the light-emitting units to turn on or off.

Preferably, the holding portion has multiple sleeves made of metal, inserted into the holding portion through the outer end, extending inwards, and internally threaded. The cap portion has multiple bands formed on an inner wall of the cap portion with multiple through holes respectively formed through the multiple bands and corresponding to the multiple sleeves. Multiple screws are mounted through the through holes of the multiple bands and the sleeves to securely mount the cap portion on the outer end of the holding portion.

Preferably, the holding portion has two ring-shaped seals formed on and protruding from an inner wall of the holding portion and being respectively adjacent to the inner end and the outer end of the holding portion for preventing water from entering the body through the inner end of the holding portion and through an junction between the holding portion and the cap portion.

Preferably, the control switch is mounted on the holding portion and is adjacent to the inner end of the holding portion.

Preferably, the warning lamp further includes a socket connector mounted on the cap portion and electrically connected to the power supply through the circuit board to further connect to another socket connector for charging the power supply.

Preferably, the two see-through portions are oppositely formed on a periphery of the cap portion for light emitted from the two light-emitting units in the mounting chamber to pass through the see-through portion and direct to a forward direction and a back direction.

Preferably, each light-emitting unit has a flexible printed circuit (FPC) board and multiple light-emitting diodes mounted on the FPC board.

The purpose of the warning lamp is to mount the warning lamp on each of the two handlebars of a bicycle for a cyclist to turn on one of the light-emitting units as a direction indicator light upon making a turn, such that the cyclists, drivers and pedestrians ahead of or behind the bicycle can be alerted to enhance safety in cycling.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a warning lamp in accordance with the present invention mounted on each handlebar of a bicycle;

FIG. 2 is an enlarged perspective view of the warning lamp in FIG. 1;

FIG. 3 is an exploded perspective view of the warning lamp in FIG. 2;

FIG. 4 is an exploded perspective view of a holding portion and a cap portion of the warning lamp in FIG. 2 assembled together by threaded connection;

FIG. 5 is a side view of the warning lamp in FIG. 2;

FIG. 6 is a functional block diagram of the warning lamp in FIG. 2;

FIG. 7 is a schematic diagram of a second embodiment of a warning lamp in accordance with the present invention; and

FIG. 8 is another schematic diagram of the warning lamp in FIG. 7.

### DETAILED DESCRIPTION OF THE INVENTION

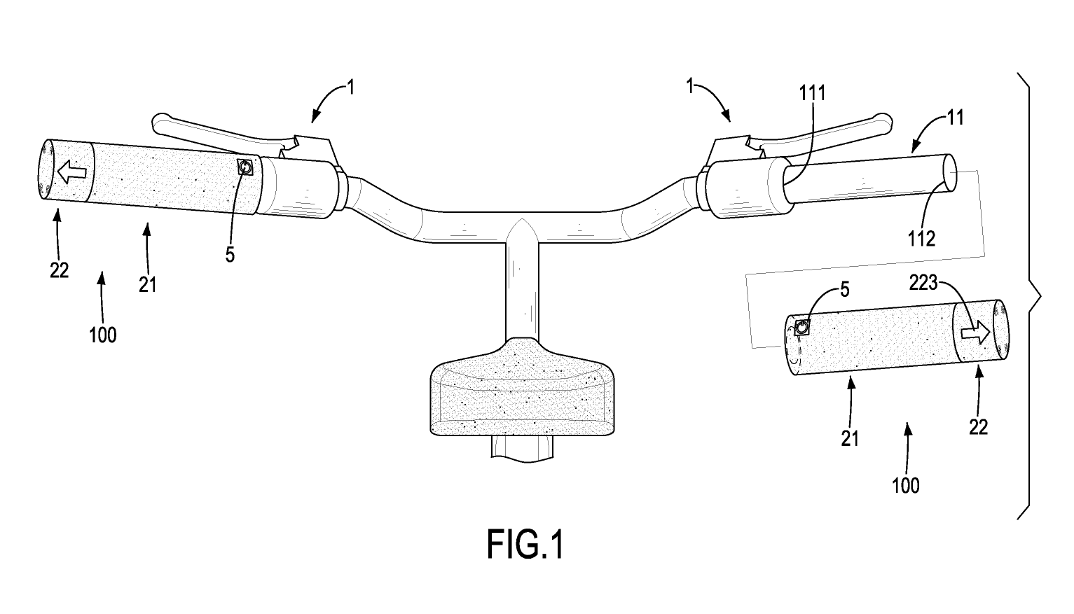

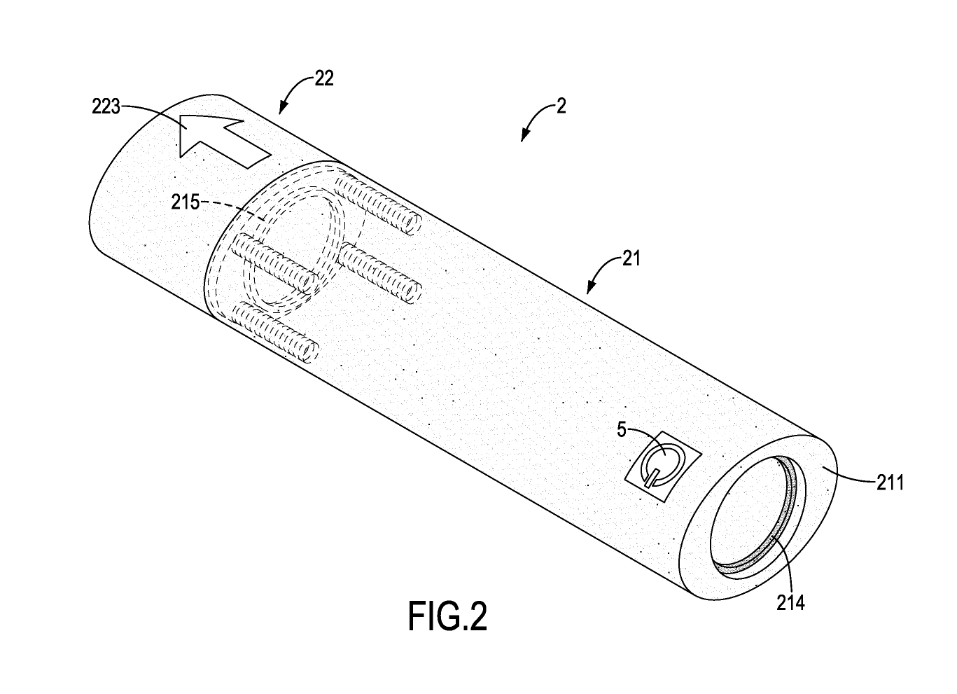

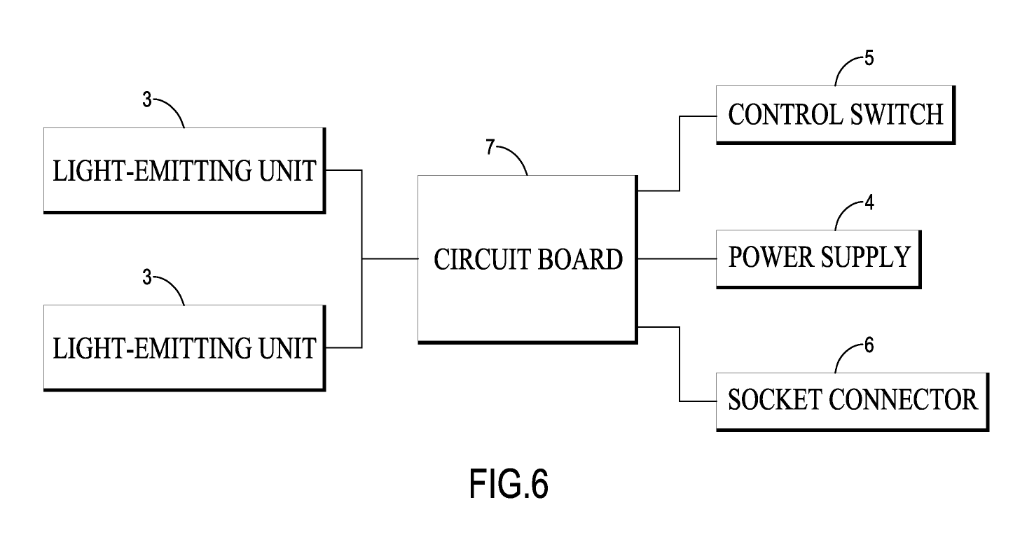

With reference to FIGS. 1, 2, 5 and 6, a warning lamp for a bicycle 100 in accordance with the present invention is mounted on each of the two handlebars 1 of a bicycle. Each handlebar 1 has a hollow bar 11, a connection end 111 and a free end 112. The connection end 111 is connected to a frame of the bicycle. The free end 112 is opposite to the connection end 111 and has an opening The warning lamp 100 includes a body 2, a circuit board 7, two light-emitting units 3, a power supply 4, a control switch 5 and a socket connector 6. In the present embodiment, the warning lamp 100 illustrated in FIGS. 2, 3 and 4 is mounted on the handlebar 1 on the left. The difference between the warning lamp 100 mounted on the handlebar on the left and the handlebar on the right resides in the position of the control switch 5 where is located to be easily pressed the left thumb and right thumb.

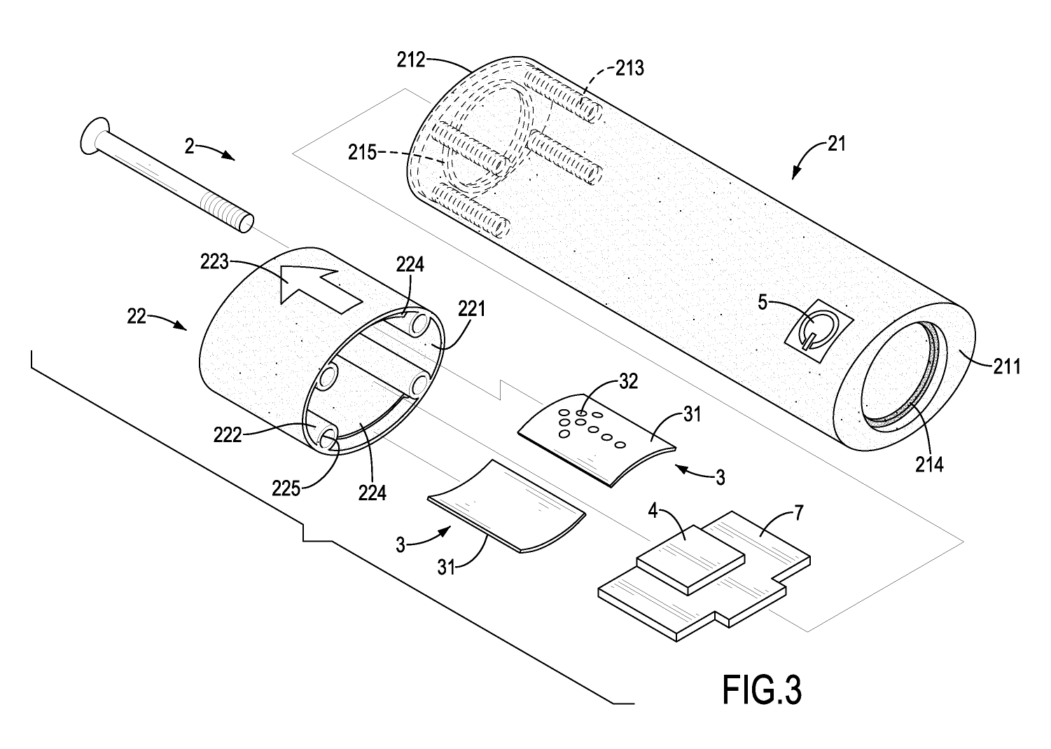

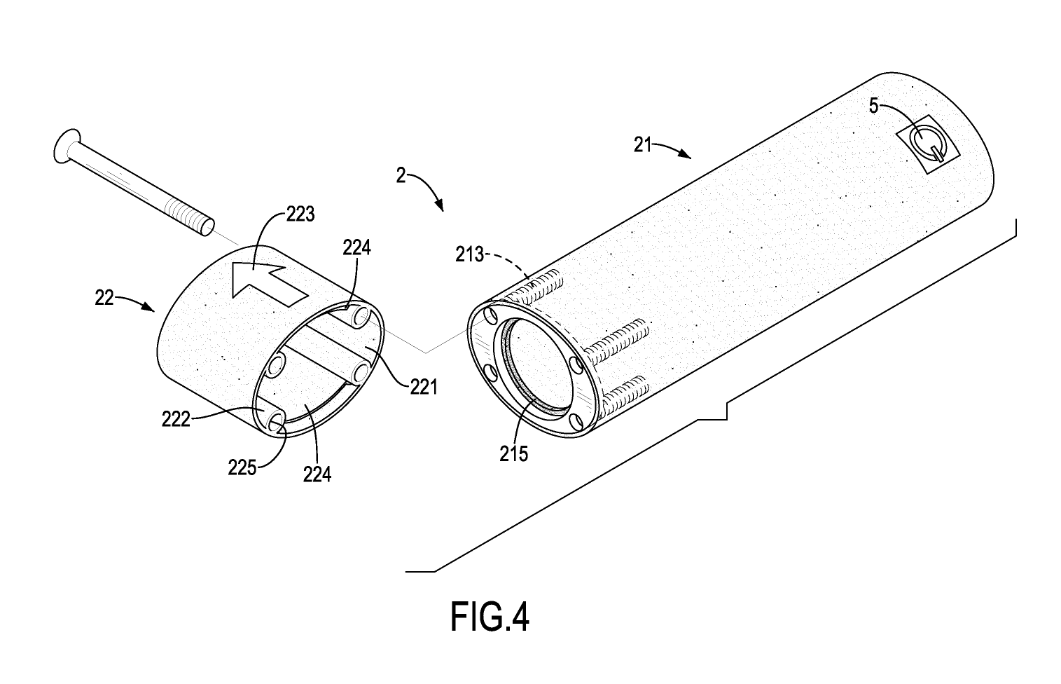

With reference to FIGS. 3 and 4, the body 2 is elliptic cylindrical and has a holding portion 21 and a cap portion 22. The holding portion 21 is integrally formed, is mounted around the handlebar 1 on the left, and has an inner end 211, an outer end 212, multiple sleeves 213 and two ring-shaped seals 214, 215. The inner end 211 corresponds to the connection end 111 of the handlebar 1. The outer end 212 corresponds to the free end 112 of the handlebar 1. The multiple sleeves 213 are made of metal, are inserted into the holding portion 21 through the outer end 212 and extend inwards, and are internally threaded. The two ring-shaped seals 214, 215 are formed on and protrude from an inner wall of the holding portion 21 and are respectively adjacent to the inner end 211 and the outer end 212 of the holding portion 21 for preventing water from entering the body 2 through the inner end 211 of the holding portion 21 and through an junction between the holding portion 21 and the cap portion 22. The cap portion 22 has a mounting chamber 221 and multiple bands 222. The mounting chamber 221 is defined inside the cap portion 22. The multiple bands 222 are formed on an inner wall of the cap portion 22 with multiple through holes 225 respectively formed through the multiple bands 222 and corresponding to the multiple sleeves 213. Multiple screws are used to mount through the through holes 225 of the multiple bands 222 and the sleeves to securely mount the cap portion 22 on the outer end 212 of the holding portion 21.

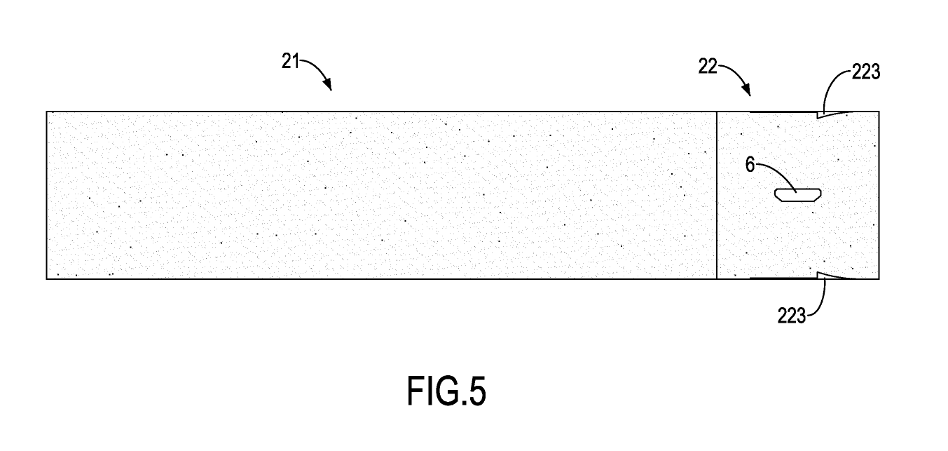

The circuit board 7 is mounted inside the mounting chamber 221 of the cap portion 22 of the body 2. Each light-emitting unit 3 includes a flexible printed circuit (FPC) board 31 and multiple light-emitting diodes (LEDs) 32 mounted on the FPC board 31. The cap portion 22 further has two partition plates 224 and two see-through portions 223. Each partition plate 224 is mounted inside the cap portion 22 to define an insertion room in the mounting chamber 221 and between the inner wall of the cap portion 22 and the partition plate 224 for one of the FPC 31 to be mounted therein. The two see-through portions 223 are oppositely formed on the periphery of the cap portion 22 and are adjacent to the respective FPC boards 32. Each see-through portion 223 takes the form of an arrow symbol. The LEDs on the FPC board 31 are arranged to take the form of an arrow corresponding to that of a corresponding see-through portion 223, such that light emitted from the LEDs on the two FPC boards 31 is oppositely directed to the see-through portions 223. In other words, light emitted from the LEDs is directed to a front direction and a back direction. Specifically, the FPC boards 31 can be bent and mounted on the inner wall of the cap portion 22 according to the curvature of the inner wall to make the LEDs on the FPC boards 31 closely attached to and aligning with the see-through portions 223. The two see-through portions 223 are respectively located on two surfaces with smaller curvatures (more flat surfaces) of the elliptic cylindrical of the body 2. When the warning lamp 100 is mounted around the handlebar 1, the two see-through portions 223 are adjusted to face a front direction and a back direction for pedestrians, cyclists and drivers ahead of or behind the bicycle to see light emitting from the see-through portions 223 and to be alerted. The cap portion 22 is made of a light-passing material and may be fully transparent or partially transparent. The power supply 4 is mounted on and electrically connected to the circuit board 7 to supply power to and light up the light-emitting units 3. The control switch 5 is mounted on the holding portion 21, is electrically connected to the circuit board 7 to control the light-emitting units 3 to turn on or off, and is adjacent to the inner end 211 of the holding portion 21 for a corresponding thumb of a cyclist to easily press the control switch 5. With reference to FIG. 5, the socket connector 6 is mounted on the cap portion 22 and is electrically connected to the power supply 4 through the circuit board 7 so as to connect to another socket connector for charging the power supply 4. Specifically, the socket connector 6 complies with the universal serial bus (USB) transmission standard and may be connected to a mobile power bank for charging the power supply 4. In the present embodiment, the power supply 4 is a rechargeable battery. The power supply 4 may be a disposable battery and the socket connector 6 can be ignored.

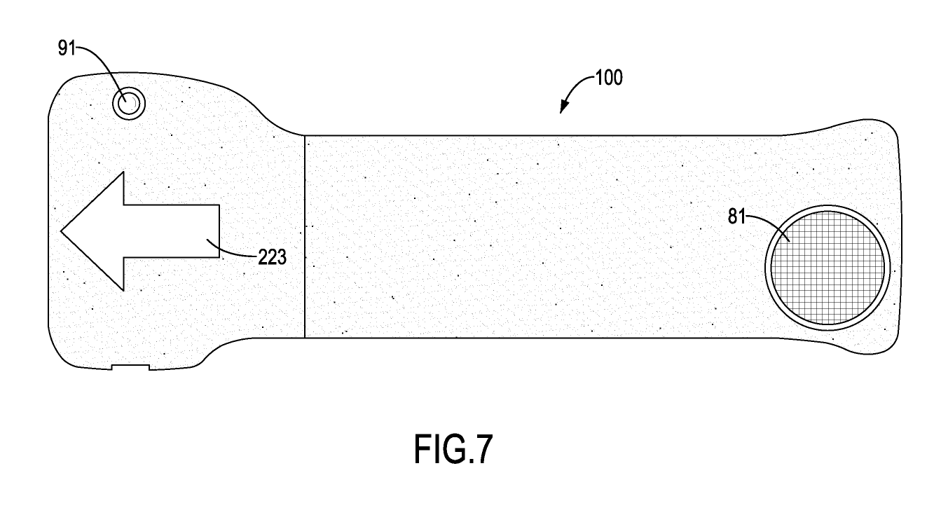

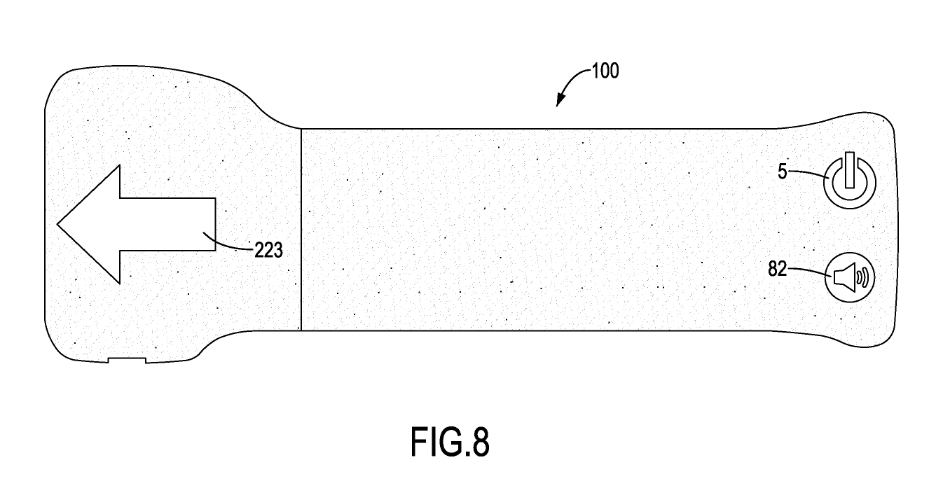

With reference to FIGS. 7 and 8, a second embodiment of a warning lamp 100 in accordance with the present invention is shown. The warning lamp 100 further has a speaker 81, a sound switch 82 and a camera 91. The speaker 81 is mounted on the holding portion 21 of the body, is adjacent to the inner end 211 of the holding portion 21, and is electrically connected to the circuit board 7. The sound switch 82 is mounted on the holding portion 21, is adjacent to the inner end 211 of the holding portion 21, and is electrically connected to the circuit board 7. When the sound switch 82 is pressed, an alert sound announcing procedure built in the circuit board is initiated to send out an alert sound to warn surrounding people. When the sound switch 82 is released, the alert sound announcing procedure is terminated to stop sending out the alert sound. The camera 91 is mounted on the cap portion 22 of the body 2 of one of the two warning lamps 100 mounted on the two handlebars 1 to record surrounding environment upon cycling.

Even though numerous characteristics and advantages of the present invention have been set forth in the foregoing description, together with details of the structure and function of the invention, the disclosure is illustrative only.

Changes may be made in detail, especially in matters of shape, size, and arrangement of parts within the principles of the invention to the full extent indicated by the broad general meaning of the terms in which the appended claims are expressed.

What is claimed is:

1. A warning lamp for a bicycle mounted on each of two handlebars of a bicycle, wherein each handlebar has a hollow bar, a connection end and a free end, the connection end is connected to a frame of the bicycle, and the free end is opposite to the connection end, the warning lamp comprising:
a body having:
a holding portion adapted to mount around the hollow bar of each handlebar of the bicycle and having:
an inner end adapted to correspond to the connection end of the handlebar; and
an outer end adapted to correspond to the free end of the handlebar; and
a cap portion connected with the outer end of the holding portion of the body and having a mounting chamber defined inside the cap portion;
a circuit board mounted inside the mounting chamber of the cap portion;
two light-emitting units mounted inside the mounting chamber and electrically connected to the circuit board;
a power supply electrically connected to the circuit board to supply power to and light up the two light-emitting units; and
a control switch mounted on the holding portion of the body, and electrically connected to the circuit board to control the light-emitting units to turn on or off.

2. The warning lamp as claimed in claim 1, wherein
the holding portion has multiple sleeves made of metal, inserted into the holding portion through the outer end, extending inwards, and internally threaded;
the cap portion has multiple bands formed on an inner wall of the cap portion with multiple through holes respectively formed through the multiple bands and corresponding to the multiple sleeves; and
multiple screws are mounted through the through holes of the multiple bands and the sleeves to securely mount the cap portion on the outer end of the holding portion.

3. The warning lamp as claimed in claim 2, wherein the holding portion has two ring-shaped seals formed on and protruding from an inner wall of the holding portion and being respectively adjacent to the inner end and the outer end of the holding portion for preventing water from entering the body through the inner end of the holding portion and through an junction between the holding portion and the cap portion.

4. The warning lamp as claimed in claim 3, wherein the control switch is mounted on the holding portion and is adjacent to the inner end of the holding portion.

5. The warning lamp as claimed in claim 4, further comprising a socket connector mounted on the cap portion and electrically connected to the power supply through the circuit board to further connect to another socket connector for charging the power supply.

6. The warning lamp as claimed in claim 1, wherein the two see-through portions are oppositely formed on a periphery of the cap portion for light emitted from the two light-emitting units in the mounting chamber to pass through the see-through portion and direct to a forward direction and a back direction.

7. The warning lamp as claimed in claim 1, wherein each light-emitting unit has a flexible printed circuit (FPC) board and multiple light-emitting diodes mounted on the FPC board.
